(19) United States
(12) Patent Application Publication
(10) Pub. No.: US 2015/0254223 A1
(43) Pub. Date: Sep. 10, 2015

(54) NON-TRANSITORY COMPUTER READABLE MEDIUM, INFORMATION PROCESSING APPARATUS, AND ANNOTATION-INFORMATION ADDING METHOD

(71) Applicant: FUJI XEROX CO., LTD., Tokyo (JP)

(72) Inventors: Shigeyuki SAKAKI, Kanagawa (JP); Yasuhide MIURA, Kanagawa (JP); Keigo HATTORI, Kanagawa (JP); Yukihiro TSUBOSHITA, Kanagawa (JP); Tomoko OKUMA, Kanagawa (JP)

(73) Assignee: FUJI XEROX CO., LTD., Tokyo (JP)

(21) Appl. No.: 14/509,394

(22) Filed: Oct. 8, 2014

(30) Foreign Application Priority Data
Mar. 4, 2014 (JP) 2014-041519

(51) Int. Cl. G06F 17/24; G06N 99/00

(52) U.S. Cl. CPC G06F 17/241; G06N 99/005

(57) ABSTRACT

A non-transitory computer readable medium stores an annotation-information adding program that causes a computer to function as an adding unit, an evaluating unit, and a setting unit. The adding unit adds annotation information to target information including multiple targets based on input from a first inputter. The evaluating unit evaluates reliability of the first inputter and reliability of a second inputter by comparing annotation information already added to at least one of the multiple targets by the second inputter with annotation information added by the first inputter. The setting unit sets a target range in the target information intended for requesting the first inputter to add annotation information based on the reliability of the first inputter and the reliability of the second inputter.

### CROSS-REFERENCE TO RELATED APPLICATIONS

This application is based on and claims priority under 35 USC 119 from Japanese Patent Application No. 2014-041519 filed Mar. 4, 2014.

### BACKGROUND

### Technical Field

The present invention relates to non-transitory computer readable media, information processing apparatuses, and annotation-information adding methods.

### SUMMARY

According to an aspect of the invention, there is provided a non-transitory computer readable medium storing an annotation-information adding program that causes a computer to function as an adding unit, an evaluating unit, and a setting unit. The adding unit adds annotation information to target information including multiple targets based on input from a first inputter. The evaluating unit evaluates reliability of the first inputter and reliability of a second inputter by comparing annotation information already added to at least one of the multiple targets by the second inputter with annotation information added by the first inputter. The setting unit sets a target range in the target information intended for requesting the first inputter to add annotation information based on the reliability of the first inputter and the reliability of the second inputter.

### BRIEF DESCRIPTION OF THE DRAWINGS

Exemplary embodiments of the present invention will be described in detail based on the following figures, wherein:

FIG. 1 is a block diagram illustrating a configuration example of an information processing apparatus according to a first exemplary embodiment;

FIG. 2 schematically illustrates a configuration example of annotation target information and annotation information;

FIG. 3 schematically illustrates a configuration example of annotator information;

FIG. 4 schematically illustrates a configuration example of the annotation target information and the annotation information;

FIG. 5 is a flowchart illustrating an example of the operation of the information processing apparatus;

FIG. 6 schematically illustrates a configuration example of annotator meta-information added to the annotator information;

FIG. 7 schematically illustrates a configuration example of the annotation target information and the annotation information;

FIG. 8 is a block diagram illustrating a configuration example of an information processing apparatus according to a second exemplary embodiment; and

FIG. 9 schematically illustrates a configuration example of learning information.

### DETAILED DESCRIPTION

### First Exemplary Embodiment

### Configuration of Information Processing Apparatus

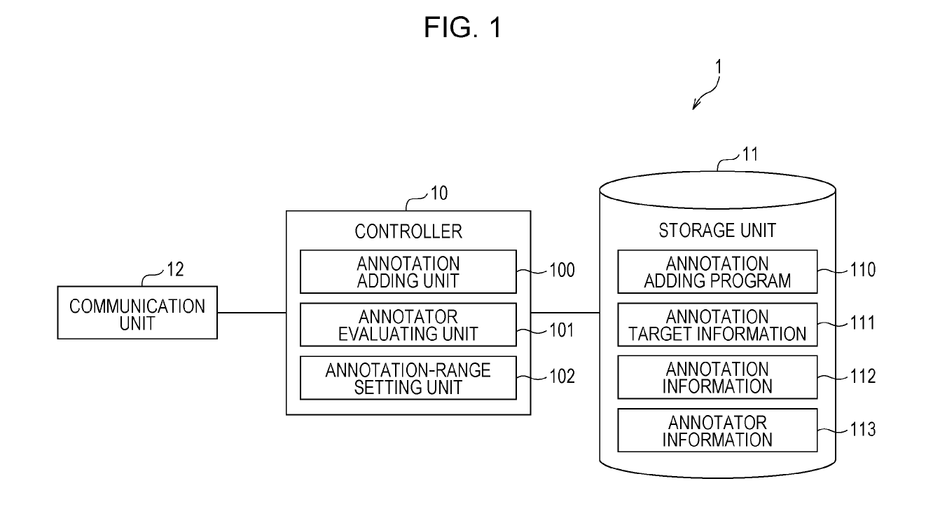

FIG. 1 is a block diagram illustrating a configuration example of an information processing apparatus according to a first exemplary embodiment.

An information processing apparatus 1 is connected to an external network via a communication unit 12 and is configured to request a user, such as a terminal connected to the external network, to add an annotation, which is annotation information indicating, for example, the characteristics of information, to annotation target information 111, such as text information, image information, or audio information, based on cloud sourcing (a user acting as an inputter who adds an annotation will be referred to as “annotator” hereinafter). Moreover, the information processing apparatus 1 is configured to receive an annotation input by an annotator and add the annotation to the annotation target information 111. An annotation may be of a binary type, such as “positive” and “negative”, or may be categorized into multiple values by preparing multiple categories.

The information processing apparatus 1 is constituted of, for example, a central processing unit (CPU) and includes a controller 10 that controls each section and executes various kinds of programs, a storage unit 11 that is constituted of a storage medium, such as a flash memory, and stores information, and the communication unit 12 that communicates with the outside via a network.

The controller 10 executes an annotation adding program 110, to be described later, so as to function as, for example, an annotation adding unit 100, an annotator evaluating unit 101, and an annotation-range setting unit 102.

The annotation adding unit 100 receives an annotation input by an annotator and adds the annotation to some of multiple annotation targets included in the annotation target information 111. The added annotation is set in association with the corresponding annotation target and is stored as annotation information 112 into the storage unit 11.

With respect to the same annotation target, the annotator evaluating unit 101 compares an annotation currently added thereto by an annotator with an annotation added thereto by another annotator in the past so as to evaluate the reliability of the annotator currently adding the annotation and the reliability of the annotator having added the annotation in the past. The evaluation method will be described in detail later. The evaluation result is stored as annotator information 113 into the storage unit 11.

The annotation-range setting unit 102 sets an annotation-target range within the annotation target information 111 intended for a request to the annotator currently adding the annotation based on the annotator information 113, which is the evaluation result obtained by the annotator evaluating unit 101. In other words, the annotation-range setting unit 102 determines which of the annotation targets is intended for a request for addition of an annotation. The range setting method will be described in detail later.

The storage unit 11 stores, for example, the annotation adding program 110 that causes the controller 10 to function as the aforementioned units 101 and 102, the annotation target information 111, the annotation information 112, and the annotator information 113.

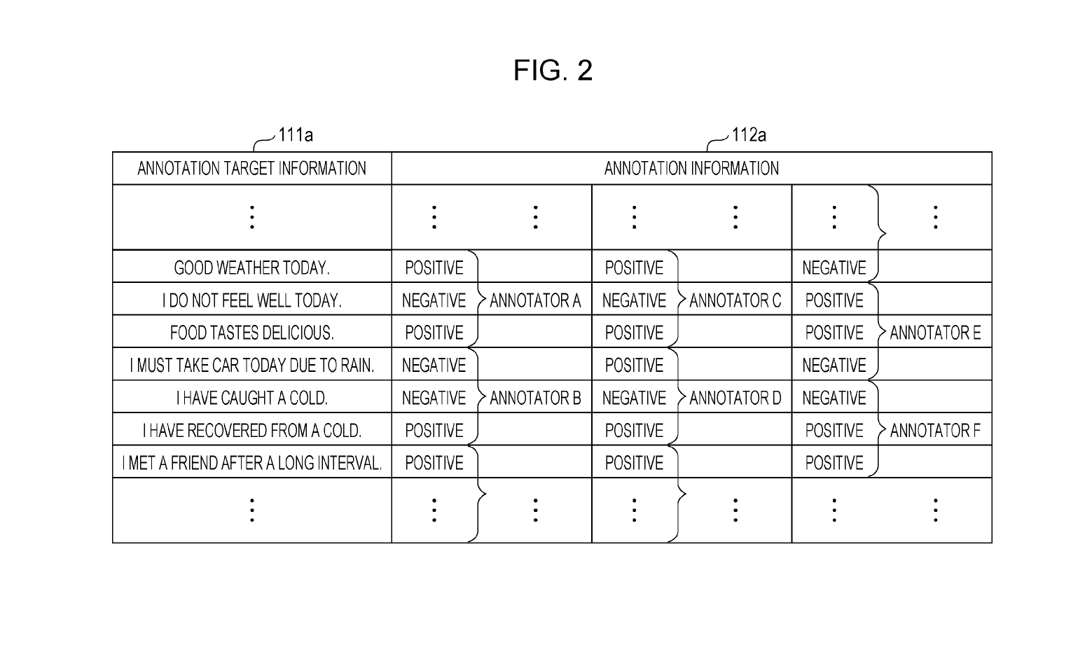

FIG. 2 schematically illustrates a configuration example of the annotation target information 111 and the annotation information 112.

Annotation target information 111a is an example of the annotation target information 111. In this example, it is assumed that verbal information is to be annotated, and the annotation target information 111a is text information containing multiple texts, such as “good weather today”, as an annotation target.

Annotation information 112a is an example of the annotation information 112 and includes an annotation added to each annotation target in the annotation target information 111a.

In the example shown in FIG. 2, there are three annotators who are requested to add annotations to the texts in the annotation target information 111a, and there are three annotation targets to which the annotations are to be added by the annotators. Each annotation to be added is either “positive” or “negative”.

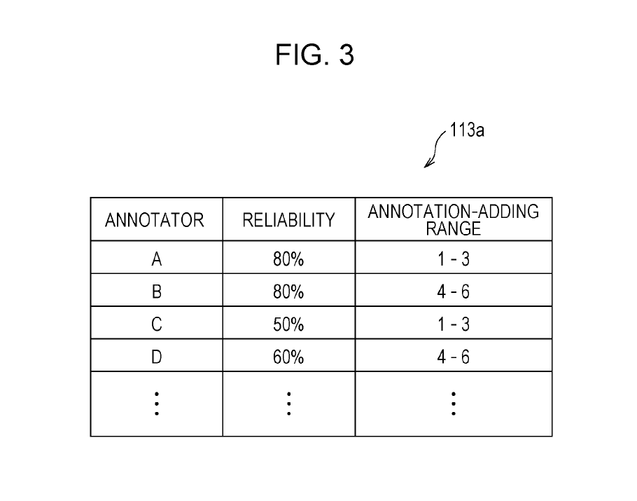

FIG. 3 schematically illustrates a configuration example of the annotator information 113.

Annotator information 113a is an example of the annotator information 113 and has an annotator field for identifying annotators, a reliability field indicating the reliability of each annotator, and an annotation-adding-range field indicating an annotation-target range within the annotation target information 111 to which an annotation is added by each annotator.

### Operation of Information Processing Apparatus

Next, the operation according to the first exemplary embodiment will be described with reference to FIGS. 1 to 5.

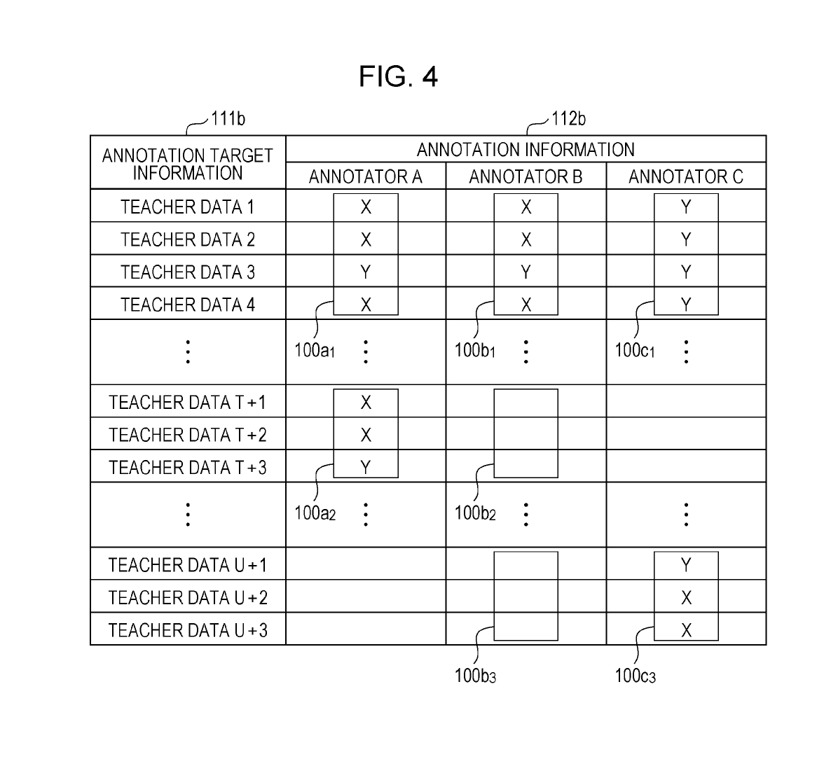

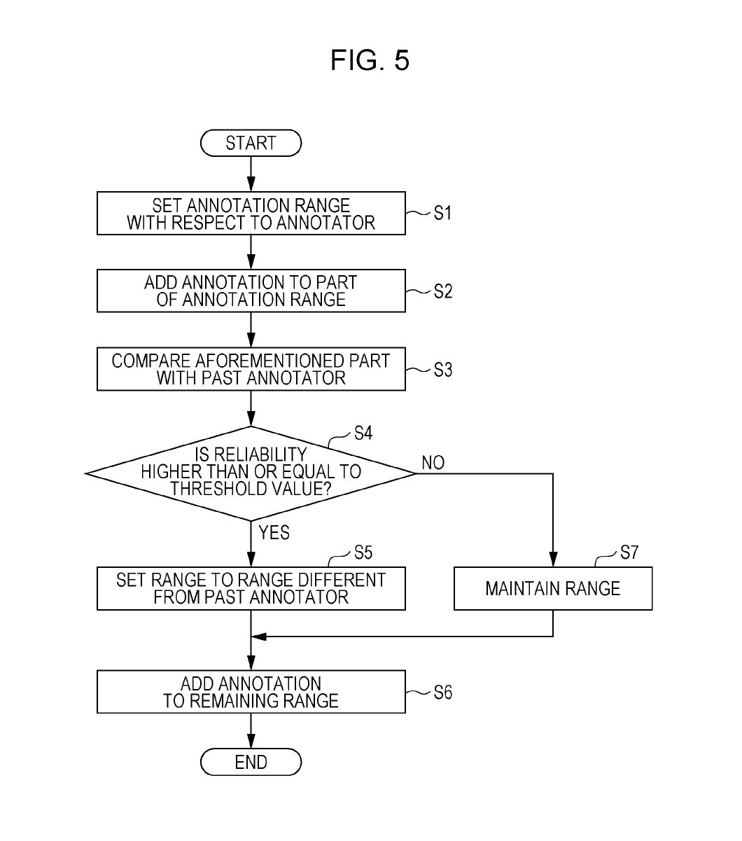

FIG. 4 schematically illustrates a configuration example of the annotation target information 111 and the annotation information 112. FIG. 5 is a flowchart illustrating an example of the operation of the information processing apparatus.

The example to be described below relates to a case where annotations have already been added by an annotator A and an annotator C, and an annotator B is requested to add annotations. Moreover, there are three annotators requested to add annotations to annotation targets in annotation target information 111b, and each annotator adds annotations to seven annotation targets.

First, in step S1, the annotation-range setting unit 102 sets seven annotation targets in the annotation target information 111b shown in FIG. 4, that is, “teacher data 1” to “teacher data 4” and “teacher data T+1” to “teacher data T+3”, as annotation-adding ranges 100b₁ and 100b₂.

Then, in step S2, when the annotation adding unit 100 requests the annotator B to add annotations to a part of the ranges 100b₁ and 100b₂, such as “teacher data 1” to “teacher data 4” in the range 100b₁, and receives annotations input by the annotator B, the annotation adding unit 100 adds an annotation to each of “teacher data 1” to “teacher data 4”. At this point, annotation information 112b is in a state shown in FIG. 4.

Subsequently, in step S3, the annotator evaluating unit 101 compares the annotations added to the range 100b₁ by the annotator B with the annotations added to a range 100a₁ by the annotator A in the past and the annotations added to a range 100c₁ by the annotator C in the past so as to evaluate the reliability of each of the annotator A, the annotator B, and the annotator C.

In the example shown in FIG. 4, the annotations in the range 100a₁ and the annotations in the range 100b₁ match, but do not match the annotations in the range 100c₁ except for “teacher data 3”. Therefore, the annotator evaluating unit 101 increases the reliability of the annotator A and the annotator B and reduces the reliability of the annotator C in the annotator information 113a. At this point, the reliability of each of the annotator A and the annotator B is at 80% and the reliability of the annotator C is at 50%, as shown in the annotator information 113a in FIG. 3.

Subsequently, in step S4, the annotation-range setting unit 102 refers to the annotator information 113a to determine whether the reliability of each of the annotator A and the annotator B is higher than or equal to a predetermined threshold value. For example, if the reliability is higher than or equal to 70% (YES in step S4), the annotation-range setting unit 102 sets the annotator-B-requesting range in the annotation target information 111b to a range 100b₃, which has no annotations added thereto, in step S5 so as to avoid a range 100b₂ that overlaps the range 100a₂ having annotations added thereto by the highly-reliable annotator A.

This is because there is a high possibility of redundant addition of highly-reliable annotations if the highly-reliable annotator B is requested to similarly add annotations to the same range as the highly-reliable annotator A. In addition, the highly-reliable annotator B is requested to add annotations to the same range as the annotator C with low reliability so that redundant addition of low-reliability annotations may be avoided.

Although the annotation adding unit 100 evaluates that the annotator A and the annotator B are highly reliable when the annotations added by the two annotators match, the annotation adding unit 100 may alternatively evaluate that annotators are highly reliable when the annotations added by n annotators (n≧3) match.

Subsequently, in step S6, the annotation adding unit 100 requests the annotator B to add annotations to the range 100b₃, that is, “teacher data U+1” to “teacher data U+3”. When receiving annotations input by the annotator B, the annotation adding unit 100 adds the annotations to the range 100b₃.

If the annotation-range setting unit 102 referring to the annotator information 113a determines that the reliability of another annotator is lower than the threshold value in step S4, such as lower than 70% (NO in step S4), the annotation-range setting unit 102 maintains the seven originally-set texts of “teacher data 1” to “teacher data 4” and “teacher data T+1” to “teacher data T+3” as the annotation-adding ranges in step S7.

According to the first exemplary embodiment described above, the reliability of each annotator is evaluated based on a currently-input annotation and an annotation input in the past. If a highly-reliable annotator has added an annotation in the past, the range thereof in the annotation target information 111 is excluded from the annotation-adding range of the annotator currently adding the annotation. Therefore, when multiple annotators are requested to add annotations, redundant addition of highly-reliable annotations may be suppressed.

### First Modification

Meta-information described below may be added to the annotator information 113 according to the first exemplary embodiment described above, and the annotator evaluating unit 101 may evaluate each annotator based on this information.

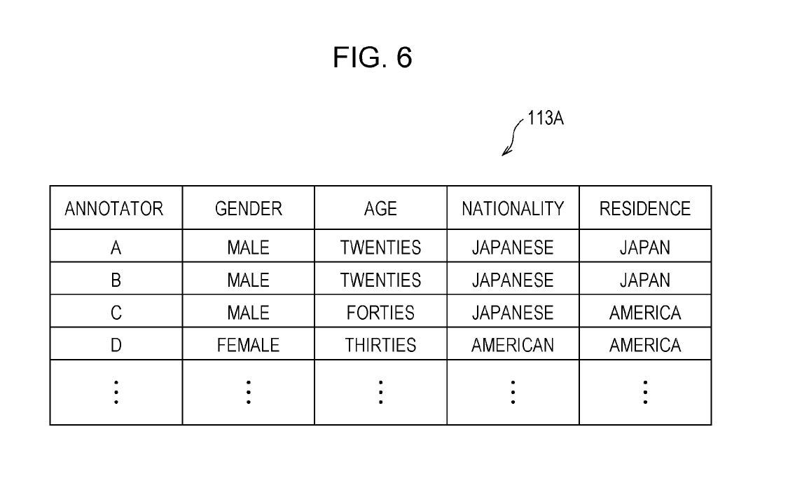

FIG. 6 schematically illustrates a configuration example of annotator meta-information added to the annotator information 113.

Annotator meta-information 113A has an annotator field for identifying annotators, a gender field indicating the gender of each annotator, an age field indicating the age of each annotator, a nationality field indicating the nationality of each annotator, and a residence field indicating the residence of each annotator.

For example, if the annotation target information 111 includes contents related to a trend in Japan, the annotator evaluating unit 101 may compare annotations as described in the first exemplary embodiment based on an assumption that highly-reliable annotations are to be added by annotators A and B residing in Japan. Based on whether the annotations match or do not match, the annotator evaluating unit 101 may evaluate the annotators A and B.

### Second Modification

As an alternative to comparing annotators based on whether annotations match or do not match, as in the first exemplary embodiment described above, the annotator evaluating unit 101 may evaluate a single annotator as described below. This method may be performed in combination with the evaluation method according to the first exemplary embodiment or may be performed independently.

For example, the annotator evaluating unit 101 calculates an entropy of the annotation information 112 added by a certain annotator. This is because an unserious annotator may conceivably add a single annotation to all data. If the calculated entropy is small, the annotator evaluating unit 101 may evaluate that the annotator has low reliability.

As an alternative to the first and second modifications described above, the reliability evaluation process may be performed in combination with the related art, such as “making an annotator self-report one's own work quality”, “monitoring annotator's work process”, or “using the reliability of an annotator evaluated in another annotation process performed in the past”. This naturally allows for improved evaluation accuracy.

### Third Modification

In addition to the operation of the annotation-range setting unit 102 described in the first exemplary embodiment, the annotation-range setting unit 102 may operate as follows.

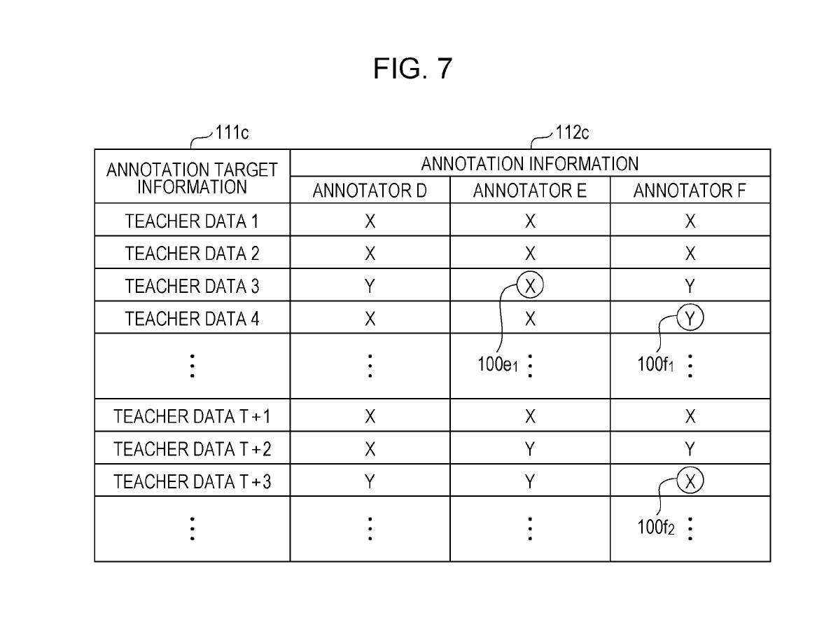

FIG. 7 schematically illustrates a configuration example of the annotation target information 111 and the annotation information 112.

It is assumed that, when annotation information 112c is added to annotation target information 111c, the annotations for “teacher data 3”, “teacher data 4”, and “teacher data T+3” in ranges 100ₑ₁, 100_{f1}, and 100_{f2}, respectively, are incorrect annotations.

Furthermore, it is assumed that the reliability of each of annotators D, E, and F is lower than a threshold value (70%) but higher than or equal to a second predetermined threshold value (60%).

In the above conditions, with regard to each annotator whose reliability is lower than that of a highly-reliably annotator (70% or higher) but is ensured to a certain extent (60% or higher), if a predetermined number of annotations, such as three annotations, are added, the annotation-range setting unit 102 may determine that further annotations are not necessary in the ranges of “teacher data 1” to “teacher data T+3” in the annotation information 112c, and may request each annotator currently adding an annotation to add an annotation to another range.

### Second Exemplary Embodiment

An information processing apparatus 1A according to a second exemplary embodiment will be described below. The second exemplary embodiment is different from the first exemplary embodiment in that information to be used for machine-learning is generated based on the annotation target information 111, the annotation information 112, and the annotator information 113 and in that machine-learning is performed using the information. Components similar to those in the first exemplary embodiment are given the same reference characters.

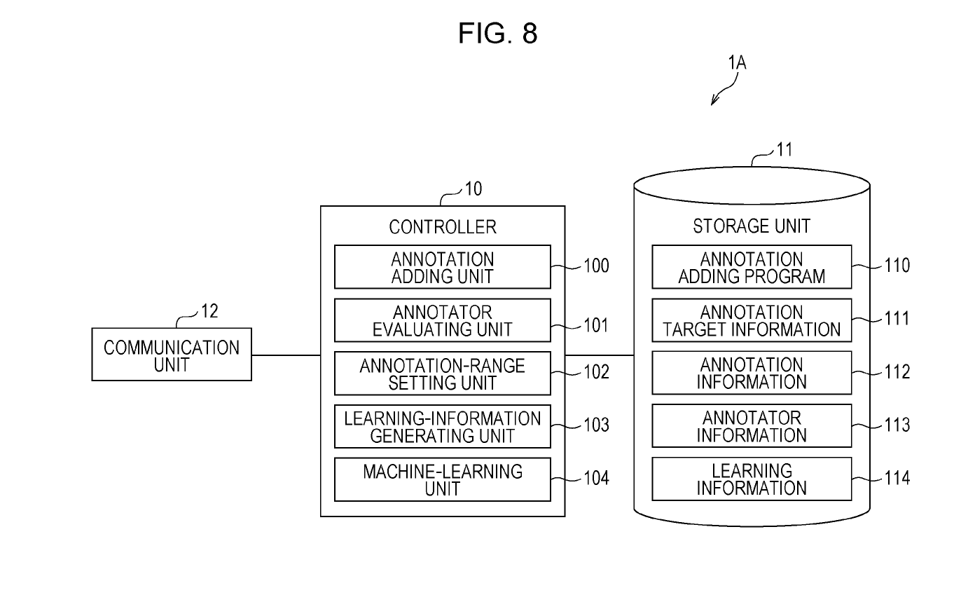

FIG. 8 is a block diagram illustrating a configuration example of the information processing apparatus according to the second exemplary embodiment.

As compared with the information processing apparatus 1 according to the first exemplary embodiment, the information processing apparatus 1A further includes a learning-information generating unit 103, a machine-learning unit 104, and learning information 114.

The learning-information generating unit 103 generates the learning information 114 based on the annotation target information 111, the annotation information 112, and the annotator information 113.

The machine-learning unit 104 executes machine-learning by using the learning information 114.

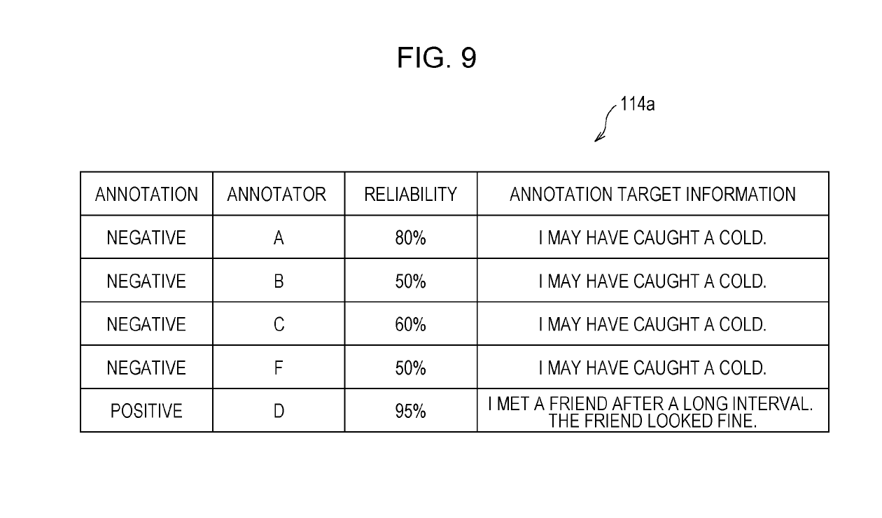

FIG. 9 schematically illustrates a configuration example of the learning information 114.

Learning information 114a is an example of the learning information 114 and has an annotation field, an annotator field, a reliability field, and an annotation-target-information field.

### Operation of Information Processing Apparatus

Next, the operation according to the second exemplary embodiment will be described.

The information processing apparatus 1A adds the annotation information 112 to the annotation target information 111 by using the units 100 to 102, and also generates the annotator information 113.

Then, the learning-information generating unit 103 further adds an item included in the annotator information 113 to general machine-learning information constituted of the annotation target information 111 and the annotation information 112 so as to obtain the learning information 114. In the example shown in FIG. 9, learning information 114a has an annotation-target-information field corresponding to the annotation target information 111 as general machine-learning information and an annotation field corresponding to the annotation information 112, and further has an annotator field included in the annotator information 113, and a reliability field.

Subsequently, the machine-learning unit 104 performs machine-learning by using the learning information 114a. In this case, each piece of the learning information 114a may be weighted in view of a value in the reliability field. Moreover, the weighting may be performed using the annotator meta-information 113A.

According to the second exemplary embodiment described above, although information to be used as machine-learning information normally includes only an annotation target and an annotation, since the reliability of an annotator is added to the machine-learning information, the machine-learning information may be generated in view of the reliability of the annotation, so that machine-learning may be executed in view of the reliability of the annotation.

### Other Exemplary Embodiments

The above-described exemplary embodiments of the present invention are not limited thereto, and various modifications are permissible so long as they are within the scope of the invention.

In each of the above-described exemplary embodiments, the functions of the units 100 to 104 in the controller 10 are realized by a program. Alternatively, all of or one or more of the units may be realized by hardware, such as an application specific integrated circuit (ASIC). Furthermore, the program used in each of the above-described exemplary embodiments may be provided by being stored in a storage medium, such as a compact disc read-only memory (CD-ROM). Moreover, switching, deletion, addition, and so on of the steps described in each of the above-described exemplary embodiments are permissible within a scope that does not alter the spirit of the exemplary embodiments of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing an annotation-information adding program causing a computer to function as:
an adding unit that adds annotation information to target information including a plurality of targets based on input from a first inputter;
an evaluating unit that evaluates reliability of the first inputter and reliability of a second inputter by comparing annotation information already added to at least one of the plurality of targets by the second inputter with annotation information added by the first inputter; and
a setting unit that sets a target range in the target information intended for requesting the first inputter to add annotation information based on the reliability of the first inputter and the reliability of the second inputter.

2. The non-transitory computer readable medium according to claim 1, wherein when the reliability of the second inputter is higher than or equal to a predetermined threshold value, the setting unit sets a target other than a target to which annotation information is added by the second inputter as the target range in the target information intended for requesting the first inputter to add annotation information.

3. The non-transitory computer readable medium according to claim 1, wherein when the reliability of a plurality of the second setters is lower than a first predetermined threshold value but is higher than or equal to a second predetermined threshold value, the setting unit sets a target other than targets to which annotation information is added by the plurality of second inputters as the target range in the target information intended for requesting the first inputter to add annotation information.

4. The non-transitory computer readable medium according to claim 1, wherein the annotation-information adding program causes the computer to further function as a generating unit that generates information as machine-learning information, the information at least having a target in the target information, annotation information added by the adding unit, and reliability of an inputter who has added the annotation information.

5. The non-transitory computer readable medium according to claim 4, wherein the annotation-information adding program causes the computer to further function as a machine-learning unit that performs machine-learning by using the information generated by the generating unit.

6. An information processing apparatus comprising:
an adding unit that adds annotation information to target information including a plurality of targets based on input from a first inputter;
an evaluating unit that evaluates reliability of the first inputter and reliability of a second inputter by comparing annotation information already added to at least one of the plurality of targets by the second inputter with annotation information added by the first inputter; and
a setting unit that sets a target range in the target information intended for requesting the first inputter to add annotation information based on the reliability of the first inputter and the reliability of the second inputter.

7. An annotation-information adding method comprising:
adding annotation information to target information including a plurality of targets based on input from a first inputter;
evaluating reliability of the first inputter and reliability of a second inputter by comparing annotation information already added to at least one of the plurality of targets by the second inputter with annotation information added by the first inputter; and
setting a target range in the target information intended for requesting the first inputter to add annotation information based on the reliability of the first inputter and the reliability of the second inputter.
